(19) United States
(12) Patent Application Publication
(10) Pub. No.: US 2001/0049927 A1
(43) Pub. Date: Dec. 13, 2001

(54) Ceiling mounted air circulation unit with filtration

(76) Inventor: Robert Toepel, New Carlisle, IN (US)

Correspondence Address: R. Tracy Crump, P.O. Box 604, New Carlisle, IN, 46552, US

(21) Appl. No.: 09/879,574

(22) Filed: Jun. 12, 2001

Related U.S. Application Data
(60) Provisional application No. 60/211,177, filed on Jun. 13, 2000.

(51) Int. Cl. B01D 46/00

(52) U.S. Cl. 55/385.2; 55/471; 55/473

(57) ABSTRACT

A modular air circulation and filtration unit, which can be conveniently installed in any conventional drop ceiling, as well as, other types of ceilings is disclosed. The circulation and filtration unit includes a housing, an electric rotary blade fan assembly, and one or more air filters. The sealed housing is shaped and dimensioned to approximate the panel space of a conventional drop ceiling or the joist spacing of conventional joist ceilings. The housing can also be modified to mount directly to the ceiling sheathing. The housing includes a flat base and an arcuate top which enclose the fan and filters. The housing also includes a hinged outlet vent and one or more hinged inlet vents, which support and provide access to the air filters. The fan assembly is mounted inside the housing interior with one or more fan cowlings isolating the fan blades from the inlet vents. In operation, the fan assembly draws air upward into the housing interior through the inlet vents and expels air downward from the interior through the outlet vent. The shape of the top guides the air flow over one or more fan cowlings within the housing interior. The fan cowlings separate the inlet and outlet air flows to reduce turbulence within the housing interior and create a laminar air flow through the housing interior.

This invention relates to a ceiling mounted air circulation and filtration unit, and in particular, a modular circulation and filtration unit, which can be readily installed in conventional drop ceilings and other types of ceilings.

### BACKGROUND OF INVENTION

Air circulation and filtration has been a persistent problem for small interior rooms in both residential and commercial applications. Ceiling and window fans are well known and commonly used in both residential and commercial applications to circulate air within an interior room to maintain an even room temperature. Window fans are only marginally effective at moving air laterally within an interior space but provide little vertical circulation. Vertical circulation is necessary to regulate temperature throughout the room. Ceiling fans provide adequate vertical circulation over window fans, but have several drawbacks.

Conventional ceiling fans are suspended from the ceiling with the fan motor and rotating fan blades extending into the room's interior space. In addition to occupying interior space, the exposed fan blades can be a hazard and obstacle to people of a tall stature. The rotating fan blades of conventional ceiling fans create oscillations and vibrations, due to weight variations in the blades, which require various balance adjustments. In addition, the vibration forces and weight of the fan itself require that ceiling fans be securely mounted to the ceiling, which precludes their use in many ceiling types. Often, ceiling fans are too heavy to be installed in a drop ceiling without additional support structures. Even in traditional drywall ceilings, ceiling fans must be mounted to joists, which limits the location of the fans within the room.

While ceiling and window fans do provide increased air circulation, they typically do not provide any air filtration. In addition, the increased circulation created by the window and ceiling fans generates a greater need for filtration. The increased air circulation often kicks up more dust and contaminants within the air, which contributes to allergies and respiratory problems for occupants. Another concern for the increased contaminants is that the contaminants in the air flow are circulated directly into the motors of ceiling and window fans, which limits the life span of the fans without the addition of some external filtering.

A wide variety of air filtration devices have been developed, but most are designed to filter particular contaminants, such as cigarette smoke in desk top applications, or chemical fumes in industrial clean room applications. While separate air filtrations devices may be employed in conjunction with the fans, circulation and filtration functions have not been integrated into an inexpensive modular unit, which is convenient for use in a wide range of ceiling types. Heretofore, no modular air circulation and filtration units have been developed that can be readily installed in a conventional drop ceiling or installed in traditional drywall ceilings.

### SUMMARY OF INVENTION

The apparatus of this invention integrates air circulation and filtration into a modular unit, which can be conveniently installed in a conventional drop ceiling, as well as other types of ceilings. Various embodiments of the circulation and filtration unit of this invention are described hereafter and can be scaled, dimensioned and modified for use in a variety of ceiling applications. In each embodiment, the circulation and filtration unit includes a housing, an electric rotary blade fan assembly, and one or more air filters. The housing is shaped and dimensioned to approximate the panel space of a conventional drop ceiling or the joist spacing of conventional joist ceilings. The housing can also be modified to mount directly to the ceiling sheathing. The housing includes a flat base and an arcuate top which encloses the fan and filters. The housing also includes a hinged outlet vent and one or more hinged inlet vents, which support the air filters. The inlet vents are hinged to the base to provide access to the filters. The fan assembly is mounted as a replacable module inside the housing. The fan assembly draws air upward into the housing interior through the inlet vents and expels air downward from the interior through the outlet vent. A fan cowling or shield is disposed within the housing, which isolates the rotating fan blades from the inlet vents. The shape of the top guides the air flow over the fan cowling within the housing interior. The fan cowling separate the inlet and outlet air flows to reduce turbulence within the housing interior and create a laminar air flow through the housing interior.

Accordingly, an advantage of this invention is that both circulation and filtration are integrated into a single modular unit, which can be mounted to any type of ceiling.

Another advantage is that the unit circulates and filters air vertically within a room to provide a uniform room temperature, thereby providing a cost savings in heating and cooling the room.

Another advantage of the circulation and filtration unit is that it is well suited for use with conventional drop ceilings.

Another advantage of this invention is that the circulation and filtration unit is inset into the ceiling space or has a low profile, thereby reducing the amount of interior room space occupied by the unit.

Another advantage is that the unit includes internal replaceable air filters, which are readily accessible through hinged inlet vents.

Another advantage is that the unit filters the air before it is drawn into the fan motor, which prolongs the life of the fan bearings and motor.

Other advantages will become apparent upon a reading of the following description.

### BRIEF DESCRIPTION OF THE DRAWINGS

The preferred embodiments of the invention have been depicted for illustrative purposes only wherein:

FIG. 1 is a top perspective view of a first embodiment of the modular circulation and filtration unit of this invention showing a portion cut away to reveal the internal components;

FIG. 2 is a top plan view of the unit of FIG. 1 showing a portion cut away to reveal the internal components;

FIG. 3 is a side sectional view of the unit of FIG. 1 mounted an a conventional drop ceiling;

FIG. 4 is a top plan view of the unit of FIG. 1 mounted between two ceiling joists of a conventional joist ceiling showing a portion cut away to reveal the internal components.

FIG. 5 is a perspective view of the second embodiment of the modular circulation and filtration unit of this invention showing a portion cut away to reveal the internal components in a conventional joist ceiling; and

FIG. 6 is a side sectional view of the unit of FIG. 5;

FIG. 7 is a side sectional view of a third embodiment of the modular circulation and filtration unit of this invention shown surface mounted to a joist ceiling.

### DESCRIPTION OF THE PREFERRED EMBODIMENT

The preferred embodiments herein described are not intended to be exhaustive or to limit the invention to the precise form disclosed. They are chosen and described to explain the invention so that others skilled in the art might utilize its teachings.

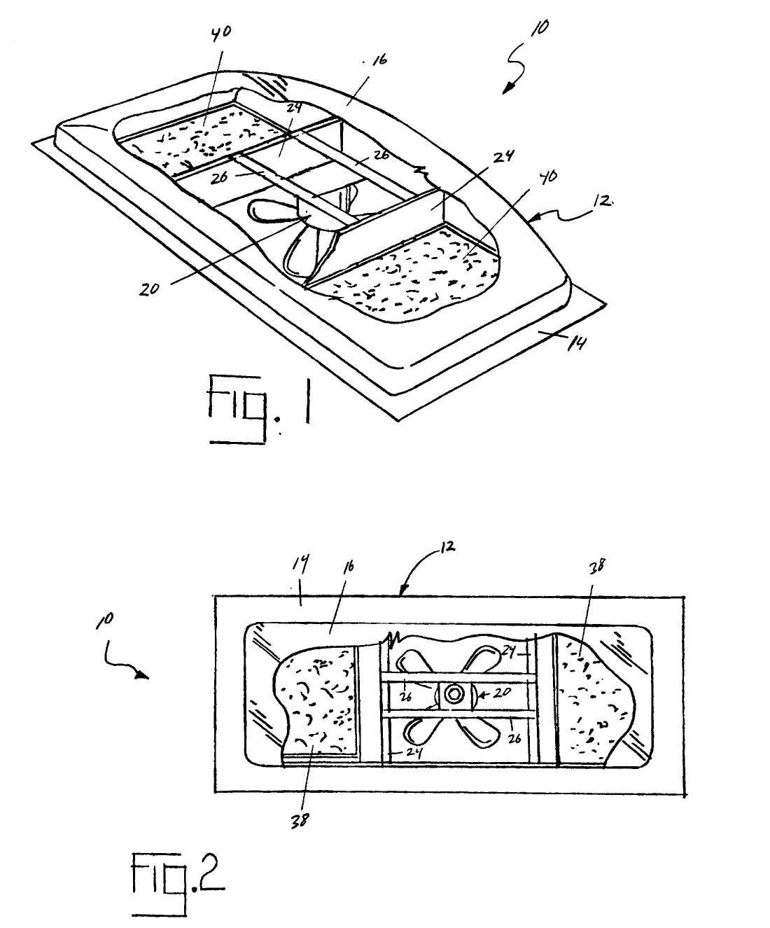

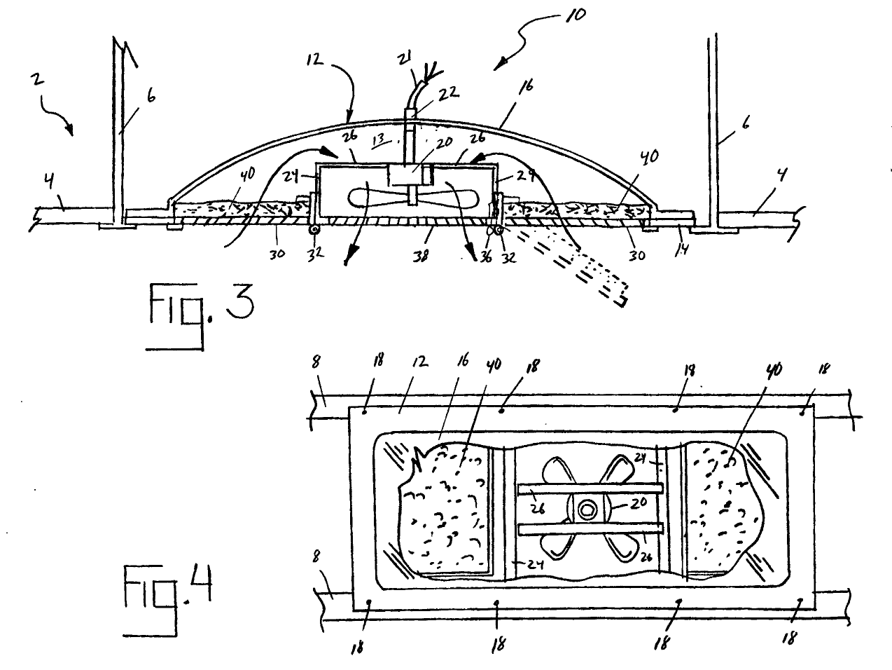

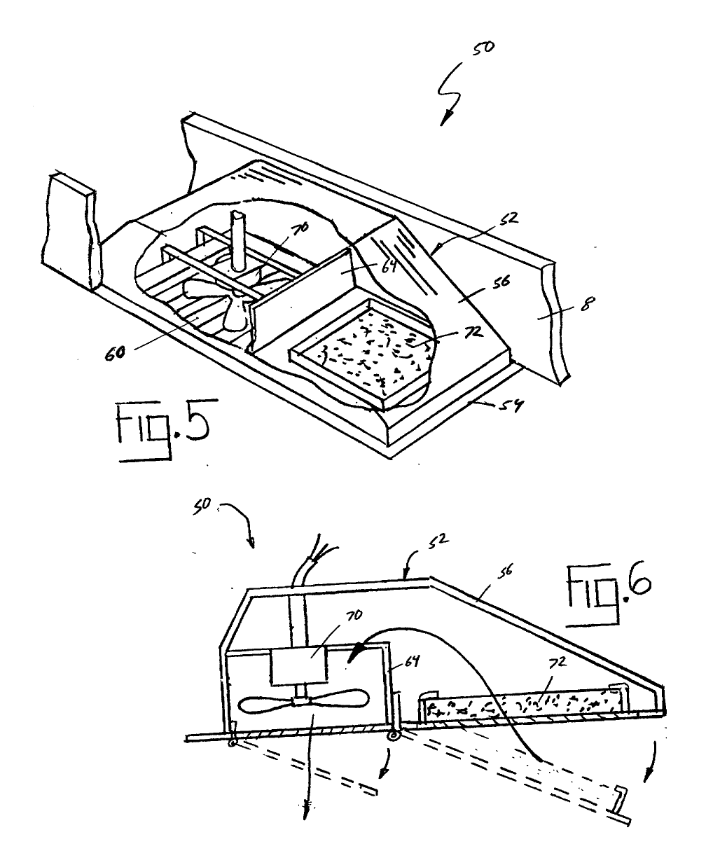

FIGS. 1-4 show the first embodiment of the modular circulation and filtration unit of this invention, designated generally as reference numeral 10. Unit 10 is designed for installation in conventional drop ceilings (FIGS. 1-3), but may be used in conventional joist ceilings (FIG. 4). Unit 10 includes a fan housing 12, an electric fan assembly 20 and a pair of air filters 40. Housing 12 has a generally rectangular shape, which is dimensioned to approximate the panel space of a conventional drop ceiling or joist spacing of conventional joist ceilings. Preferably, top 16 is constructed of a molded thermoplastic, but may be constructed of any suitable material. Housing 12 includes flat base 14 and an arcuate top 16, which are secured together to define a hermetically sealed housing interior 13 in which fan 30 and filters 40 are enclosed. Base 14 and top 16 are secured together by any conventional method, which provides a sealed engagement. Base 14 is constructed of a sturdy rigid material, such as a metal or reinforced fiberglass or plastic, which provides the structural support for the unit. As shown, the peripheral edge of base 14 allows the unit to be seated within the panel space of a drop ceiling or fastened directly to a ceiling joist.

Housing 12 also includes two hinged inlet vents 30, and a hinged outlet vent 38. A leaf hinge 32 pivotally connects inlet vents 30 to base 14 to cover the two side openings in base 14. Likewise, a third leaf hinge 36 pivotally connects outlet vent 38 to base 14 to cover the central opening directly below fan assembly 20. Each inlet vent 30 supports air filters 40. Air filters 40 are seated atop the vent planes and held in position by tabs 34. Inlet vent panels 30 are hinged to base 14 and pivot downward to access filters 40 once the unit is mounted within a ceiling. Filters 40 are of conventional design and typically uses a fibrous material to screen particulate from the air flow passing through the screen. It should be noted that this invention contemplates, while not illustrated in the drawing, the use of an additional air filter supported by outlet vent 38 to provide additional air filtration as desired.

Preferably, fan assembly 20 is a modular component, which can be readily removed from the housing 12 through hinged outlet vent 38 for maintenance and cleaning. Fan assembly 20 includes a conventional electric rotary fan with a variable speed electric motor and accompanying electrical controls. Fan 20 is sized to fit inside housing interior 13. The electrical wiring 21 from the fan motor is routed through a conduit extending out of top 16. Preferably, the fan motor is wired directly to the electrical system and operated off of a conventional wall switch. Alternatively, the fan motor can be plugged into a conventional power outlet with the wiring terminating with a wall socket plug (not shown) or powered by electrical batteries. Although not shown in the drawings, one skilled in the art will not that the fan motor can be wired to be controlled from a remote wall switch or alternatively from switches or a pull chain, that are integrated directly into the fan assembly. As shown, fan 20 is mounted to base 14 by a fan support frame, which includes a pair of fan cowlings or shields 24 and two cross members 26. Fan 20 is mounted to the cross members 26 so that the blades are downward facing and positioned between fan cowlings 24.

As shown in FIG. 3, fan assembly 20 draws air upward into the housing interior 13 through inlet vents 30 and expels air downward from the interior through outlet vent 38. The curved shape of top 16 guides the air flow over fan cowlings 24. Fan cowlings 24 separate the air flows drawn through inlet vents 30 from the air flows expelled through the outlet vent 38, which reduces turbulence within housing interior 13. The fan cowlings also isolate any turbulent air flows coming off the ends of the rotating fan blades and directs these air flows downward through the outlet vent 38.

The modular design of unit 10 allows it to be used in conventional drop ceilings or installed between the joist space of traditional drywall ceilings. FIG. 3 shows unit 10 installed in a drop ceiling 2. Conventional drop ceilings are suspended from the ceiling joists or other ceiling structures to enclose overhead pipes and fixtures and to provide a decorative ceiling. As shown in FIG. 3, a drop ceiling 2 includes a plurality of panel sections 4 supported on a suspended channel frame 6. In a drop ceiling application, unit 10 is designed to simply replace a single panel section and be wired to any convenient electrical source. A variety of fasteners, such as screws, clamps, and ties, can be used to secure base 14 to channel frame 6 to permanently mount unit 10 within the ceiling. FIG. 4 shows unit 10 installed in a typical drywall ceiling. In this ceiling application, the unit is sized to fit in the ceiling space between two ceiling joists. Typically, an opening approximately the size of unit 10 is cut in the sheath material (not shown) of the ceiling between two joists 8. Unit 10 is fastened directly to joists 8 by fasteners 18, which extend through bores in base 14. In both types of ceilings, unit 10 is mounted flush with the ceiling panels or sheathing.

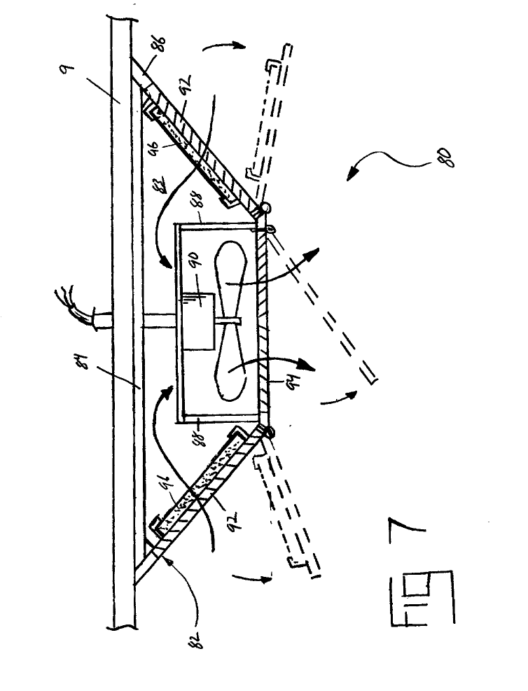

FIGS. 5 and 6 show the second embodiment of the modular ceiling unit of this invention, designated generally as reference numeral 50. Again, unit 50 is designed for installation in either a conventional drywall ceiling (a shown), or a conventional drop ceiling (not shown). Unit 50 has the same design, construction, and installation, as the unit of the first embodiment, except that it employs only one inlet vent 54. Unit 50 includes a housing 52, fan assembly 70 and filter 72. The housing includes a base 54, a curved top 56, and two vents: inlet vent 58 and outlet vent 60. As shown, fan assembly 70 is mounted to a support frame 62. Fan assembly 70 draws and expels air through the adjacent inlet and outlet vents. Again, the shape of angled top 56 guides the air flow over a fan cowling 64 within the housing interior. Fan cowling 64 separates the inlet and outlet air flows to reduce turbulence within the housing interior 53.

As shown in FIG. 5, unit 50 is designed to be best suited for installation in ceiling applications where the unit must be mounted between joists or in small panel spaces. Again, unit 50 is mounted to joists 8 by any suitable fastening means, such as screws. In such applications, the size and dimensions of unit 5 are restricted, which limits the size of the fan and therefore the circulation power of the unit. Two separate units can be installed side by side to provide the desired level of circulation and filtration. Furthermore, multiple units can be installed in any desired array or configuration.

FIG. 7 shows the third embodiment of the modular ceiling unit of this invention, designated generally as reference numeral 80. Unit 80 has a slightly different configuration and mounts directly to the ceiling sheathing, but has a similar design and construction as the units of the other embodiments. As before, unit 80 includes a housing 82, fan assembly 90 and filter 96. The housing 82 includes a mounting plate 84 and trapezoidal bottom 86 which are secured together to define a hermetically sealed housing interior 83 in which fan assembly 90 and filters 96 are enclosed. Again, the mounting plate and bottom are secured together by any conventional method that provides a sealed engagement. Fan assembly 90 is mounted to bottom 86 by a support frame, which includes a pair of fan cowlings 88. As before, housing 82 also includes two hinged inlet vents 92, and a hinged outlet vent 94 and filters 96 carried by the inlet vents. As shown in FIG. 7, fan assembly 90 draws air upward into the housing interior 83 through inlet vents 90 and expels air downward from the interior through outlet vent 38. Again, fan cowlings 88 separate the air flows drawn through inlet vents 92 from the air flows expelled through the outlet vent 94, which reduces turbulence within housing interior 83.

One skilled in the art will recognize that the modular circulation and filtration unit of this invention provides several practical advantages and improvements over conventional ceiling fans and other filtration devices. In this invention, both circulation and filtration are integrated into a single modular unit, which can be mounted to any type of ceiling. The circulation and filtration units of this invention are well suited for use with conventional drop ceilings because of their modular design and light weight construction. Since the units are installed into the internal space used for the ceiling structure, or have a low profile when surface mounted, they occupy little if any interior room space. The inlet and outlet vents provide ready access to the replaceable filters and the fan, which allows convenient maintenance of the units. The design of the units prolongs the life of the fan motor and bearings because the inlet air flow to the fan is drawn through the filters before contact with the fan. The electrical fan motor can be wired to any convenient power source and controlled in a variety of manners. Individual units are ideal for use with small rooms and apartments, and can be used in combination for large rooms and open indoor areas.

It is understood that the above description does not limit the invention to the details given, but may be modified within the scope of the following claims.

I claim:

1. An apparatus mountable to an over head drop ceiling of a room for vertically circulating and filtering air within the room, where the drop ceiling includes a plurality of panel sections and a suspended support frame having a plurality of panel spaces in which one or more of the plurality of panel sections are seated, the apparatus comprising:
a housing dimensioned to be securely seat within one of the panel spaces and defining an interior therein,
an inlet vent pivotally mounted to the housing through which air can enter the housing interior,
an outlet vent mounted to the housing adjacent the inlet vent through which air can exit the housing interior,
a filter supported by the inlet vent for filtering contaminants from the air passing through the inlet vent,
fan means mounted within the housing interior over the outlet vent and adjacent the inlet vent for drawing air upward into the housing interior through the inlet vent and the filter and for expelling air downward from the housing interior through the outlet vent.

2. The apparatus of claim 1 wherein the housing includes a cowling part disposed within the housing interior and separating the fan from the inlet vent so as to prevent turbulence within the housing interior.

3. The apparatus of claim 2 wherein the housing includes an arcuate part for directing air from the inlet vent to the fan means over the cowling part.

4. The apparatus of claim 1 and a second inlet vent, wherein the outlet vent is located between the first and second inlet vents.

5. An apparatus mountable in an over head ceiling of a room for circulating and filtering air within the room, where the ceiling includes two joists spaced parallel to each other and defining a joist space therebetween, the apparatus comprising:
an housing dimensioned to securely seat within the joist space and defining an interior therein,
an inlet vent pivotally mounted to the housing through which air can enter the housing interior,
an outlet vent mounted to the housing adjacent the inlet vent through which air can exit the housing interior,
a filter supported by the inlet vent for filtering contaminants from the air passing through the inlet vent, and
fan means mounted within the housing interior over the outlet vent and adjacent the inlet vent for drawing air upward into the housing interior through the inlet vent and the filter and for expelling air downward from the housing interior through the outlet vent.

6. The apparatus of claim 5 wherein the housing includes a cowling part disposed within the housing interior and separating the fan means from the inlet vent, so as to prevent turbulence within the housing interior.

7. The apparatus of claim 6 wherein the housing includes an arcuate part for directing air from the inlet vent to the fan means over the cowling part.

8. The apparatus of claim 5 and a second inlet vent, wherein the outlet vent is located between the first and second inlet vents.

9. An apparatus mountable to a ceiling of a room for circulating and filtering air within the room comprising:
an housing mountable to the ceiling and defining an interior therein,
means for connecting the housing to the ceiling,
an inlet vent pivotally mounted to the housing through which air can enter the housing interior,
an outlet vent mounted to the housing adjacent the inlet vent through which air can exit the housing interior,
a filter supported by the inlet vent for filtering contaminants from the air passing through the inlet vent, and
fan means mounted within the housing interior over the outlet vent and adjacent the inlet vent for drawing air upward into the housing interior through the inlet vent and the filter and for expelling air downward from the housing interior through the outlet vent.

10. The apparatus of claim 9 wherein the housing includes a cowling part disposed within the housing interior and separating the fan means from the inlet vent so as to prevent turbulence within the housing interior.

11. The apparatus of claim 10 wherein the housing includes a arcuate part for directing air from the inlet vent to the fan means over the cowling part.

12. The apparatus of claim 9 and a second inlet vent, wherein the outlet vent is located between the first and second inlet vents.
